(19) United States
(12) Patent Application Publication
(10) Pub. No.: US 2010/0001091 A1
(43) Pub. Date: Jan. 7, 2010

(54) Piezoelectric atomizer comprising a fragrancing liquid composition; fragrancing method

(75) Inventors: Isabelle Bara, La Varenne St Hilaire (FR); Virginie Albelda, Paris (FR); Carole Charbonnier-Civier, Viry Chatillon (FR)

Correspondence Address: CONNOLLY BOVE LODGE & HUTZ LLP, 1875 EYE STREET, N.W., SUITE 1100, WASHINGTON, DC, 20006, US

(73) Assignee: L'OREAL, Paris (FR)

(21) Appl. No.: 12/496,184

(22) Filed: Jul. 1, 2009

Related U.S. Application Data
(60) Provisional application No. 61/080,518, filed on Jul. 14, 2008.

(30) Foreign Application Priority Data
Jul. 2, 2008 (FR) 0854482

(51) Int. Cl. B05B 17/04; B05B 1/08

(52) U.S. Cl. 239/4; 239/102.2

(57) ABSTRACT

The invention relates to a cosmetic assembly comprising:

(A) a cosmetic or dermatological composition contained inside a reservoir, said composition being liquid and comprising, in a physiologically acceptable medium:
(i) from 1 to 90% by weight of a fragrance concentrate;
(ii) from 1 to 98.5% by weight of at least one non-volatile solvent for said concentrate having a density of less than 1;
(iii) at least from 0.5% to 50% by weight of at least one volatile alcohol for said concentrate;
said composition having a viscosity less than or equal to 8 mPa·s; the amounts being defined relative to the total weight of the composition;
(B) a spraying device comprising a container containing said liquid cosmetic composition, equipped with a piezoelectric spraying mechanism that makes it possible to spray the cosmetic composition in the form of droplets.

The invention also relates to a method of fragrancing human keratin materials and especially skin, lips, hair, scalp, nails, comprising at least one step of spraying a fragrancing composition by means of a device as defined previously.

The invention also relates to a method of fragrancing the surrounding air comprising at least one step of spraying a fragrancing composition by means of a spraying device as defined previously.

One subject of the present invention is a spraying device of the piezoelectric type comprising a fragrancing liquid composition that itself comprises at least one fragrance concentrate, at least one non-volatile solvent and a volatile solvent.

A fragrance concentrate is a mixture of odorant substances. It corresponds to a mixture of natural and synthetic components.

The fragrance concentrate is composed of a multitude of odours that are perceived simultaneously and/or successively and that perfumers usually class according to three categories:

head note
heart note
base note.
This classification is made according to the volatility of each component.

Head notes are the most volatile, they are generally fresh, light, green and fruity notes. They correspond to the first olfactory impression of the product and are responsible for the buying act. Their volatilities are so high that their presence lasts up to 30 minutes approximately.

The heart notes correspond to the intermediate notes in terms of volatility, they appear after the head notes, they constitute the heart of the fragrance, they will be smelt intensely throughout the day and constitute the major identity of the fragrance, even if it is the synergy of the three parts of the pyramid that creates the overall identity.

The base notes are heavy notes that accentuate the fragrance. They make it possible to stabilize the head and heart notes. They create a solid base for the fragrance. They may comprise amber, musky, woody, or balsamic odours. These notes are not very volatile and can last more than 5 hours. They generally correspond to the notes that last for days and days on the textile of our clothes.

Once the fragrance concentrate is produced according to a precise olfactory pyramid, it may, in general, be put into an alcoholic or aqueous-alcoholic solution to give the fragrance.

The quality of the odour is an important hedonic criterion, but other more technical criteria such as diffusion, intensity, persistence and tenacity should be considered.

Man has always sought to fragrance himself and to fragrance the objects that surround him or the places in which he is, both to mask strong and/or unpleasant odours and to give a good odour.

The fragrance is applied to various supports.

1) In cosmetics: for example in body hygiene (shower gel, shampoos, etc.), fragrancing products (eaux fraîches (splashes), eaux de toilette, eaux de parfum, extraits (extracts), face and body care products and fragranced products, makeup);
2) in functional perfumery (detergents and home fragrances), to give, in all cases, products that have a fragrance contribution.

Various means make it possible to deposit the fragrance on the skin or on other supports such as the surrounding air for air fresheners.

Perfumery generally makes use of pump bottles for eaux de toilettes, propellant gases for deodorants or detergent perfumery.

Regarding cosmetics, it is the base itself, which during its application to the skin deposits the fragrance, for example creams, milks or concretes. Functional perfumery and home perfumery relate to candles, incense, fragranced ceramics, fragranced bouquets, and fragrance diffusers.

Electric diffusers known as “plug ins” plug directly into the mains, and the technology tends to propose more and more diffusers of piezoelectric type that operate using a battery for a “mobile” advantage, but which especially offer a fine spray considerably more aesthetic and olfactorally superior in terms of the quality of release of the fragrance notes. The latter system may possibly be used for numerous fragrance or cosmetic products if the viscosity is suitable.

Many piezoelectric-type diffusers that make it possible to disperse a fragrancing composition have been proposed. The method consists in vibrating a ceramic membrane, of porous consistency, for example provided with through-holes, which will make the fragrancing composition which is conveyed to this point by a wick diffuse in the form of microdroplets. It is already known from documents WO 03/066115, WO 00/53337, U.S. Pat. No. 5,518,179, WO 02/089861, WO 06/066671, WO 07/054,920 to use vibrating plates in order to disperse a product in the form of a cloud of fine droplets. The devices described in these documents comprise a liquid product reservoir and an ejection system comprising a wall provided with one or more orifices for the passage of the product. As a variant, devices are also known from document WO 02/068128 that comprise a piezoelectric element that is provided on a wall opposite the wall equipped with distribution orifices. A piezoelectric element is provided in order, when it is deformed under the effect of an electric field, to make the wall vibrate so as to eject the product in the form of fine droplets through the orifices. In these devices, the product is conveyed to the orifices of the wall by a repeat wick that dips into the product reservoir.

Fragrance diffusers of piezoelectric type are known from Application WO 00/47335 that comprise a liquid fragrancing composition having a viscosity of less than 10 cps and having a surface tension of 20 to 35 dyn/cm in order to optimize the output of the diffusion and to minimize the consumption of the battery powering the device.

The fragrance formulations present in these types of device generally comprise a fragrance concentrate comprising volatile organic compounds (VOCs), at least one solvent for said fragrance; the viscosity of the liquid composition being adapted in order to allow the diffusion of said fragrance.

Piezoelectric-type fragrance diffusers may result in a certain number of drawbacks that it is advisable to avoid or at least to reduce the harmful effects thereof such as:

the phenomenon known as “fall out” which results in droplets falling onto the surface of the apparatus or onto its support;

the clogging up or obstruction of the apparatus;

a height and a volume of the cloud of the vaporized composition generated by the (“pshitt”) device that are visually unpleasant for the consumer;

an uncontrolled evaporation of the fragrancing solution from its reservoir or cartridge leading to a longevity of the product that is unsatisfactory for the consumer; and

the solvent or solvents used may produce an odour that affects the desired fragrance.

The need therefore remains to search for novel formulations packaged in piezoelectric-type fragrance diffusers in which the qualities of diffusion and the olfactory quality are improved, and also the longevity of the product without the drawbacks mentioned previously.

The Applicant, during numerous studies, surprisingly discovered that this objective could be achieved by using, in a piezoelectric-type spraying device, a liquid composition comprising, in a physiologically acceptable medium:

(i) from 1% to 90% by weight (preferably 5 to 30%) of a fragrance concentrate;
(ii) from 1 to 98.5% by weight of at least one non-volatile solvent for said fragrance concentrate having a density of less than 1;
(iii) at least from 0.5% to 50% by weight of at least one volatile solvent;
said composition having a viscosity less than or equal to 8 mPa·s.

This discovery is the basis of the invention.

One subject of the invention is therefore an assembly comprising:

(A) a fragrancing composition contained inside a reservoir, said composition being liquid and comprising, in a physiologically acceptable medium:
(i) from 1% to 90% by weight (preferably 5 to 30%) of a fragrance concentrate;
(ii) from 1 to 98.5% by weight of at least one non-volatile solvent for said fragrance having a density of less than 1;
said fragrance;
(iii) at least from 0.5% to 50% by weight of at least one volatile solvent for said fragrance; said composition having a viscosity less than 8 mPa·s; the amounts being defined relative to the total weight of the composition;
(B) a spraying device comprising a container containing said liquid cosmetic composition, equipped with a piezoelectric spraying mechanism that makes it possible to spray the fragrancing composition in the form of droplets.

Another subject of the invention is a method of fragrancing human keratin materials and especially skin, lips, hair, scalp, nails, comprising at least one step of spraying a fragrancing composition by means of a device as defined previously.

Another subject of the invention is a method of fragrancing the surrounding air comprising at least one step of spraying a fragrancing composition by means of a device as defined previously.

The expression “fragrancing composition” is understood to mean any composition, mixture of pure concentrate, solvents and additives necessary for preserving the composition.

The expression “fragrance concentrate” is understood to mean any scented substance in its simple form or in the form of a mixture, the two possible forms comprising the solvents necessary for the conversion of the natural substance and/or for obtaining the mixture. The fragrance concentrate applied to a support gives a fragrancing composition. This support may be cosmetic, dermatological, alcoholic, aqueous-alcoholic, or a mixture of solvents.

The expression “volatile solvent” is understood to mean any solvent for the fragrance concentrate having a vapour pressure greater than or equal to 0.01 kPa at 293.15 K or else greater than 0.1 mmHg.

The expression “volatile organic compound” is understood to mean any organic compound having a vapour pressure greater than or equal to 0.01 kPa at 293.15 K or else greater than 0.1 mmHg.

The viscosity of the composition is measured at 20° C. using a HAAKE Rheostress 600 machine with a spindle having a diameter of 60 mm, an angle of 2° and a sand-blasted coating at a shear rate of 200 s⁻¹.

The expression “physiologically acceptable medium” is understood to mean, in the composition of the invention, a medium that is non-toxic and capable of being applied to human keratin materials comprising the skin, the face, the lips, the nails, the hair, the scalp or else capable of being diffused into the atmosphere, into the surrounding air.

### Piezoelectric Spraying Device

The expression “piezoelectric spraying system” is understood, in the meaning of the present application, to mean a system that nebulizes a liquid under the action of an ultrasonic energy of appropriate frequency and power, energy produced by a piezoelectric material (transducer) excited by a high-frequency electrical signal.

According to one preferred embodiment of the invention, the piezoelectric spraying device may comprise:

a perforated membrane, the perforations of the membrane connecting the inside of the container with the outside environment;

an actuator to make the membrane vibrate;

a means for bringing the liquid cosmetic composition contained in the container into contact with an internal surface of the membrane, the cosmetic composition, under the effect of vibrations of the membrane, flowing through the perforations to an external surface of the membrane, from where it emerges in the form of droplets.

The perforations in the membrane preferably have a reverse conicity, that is to say a greater cross-sectional surface area on the outer surface of the membrane, facing the outside environment, than on the inner surface, facing the inside of the container.

The spraying device may also comprise a pressure difference means, as described in Application WO 95/15822, providing a reduced pressure to the liquid in contact with the inner surface of the membrane. The reduced pressure may vary from zero pressure up to the pressure at which the air is sucked through the perforations of the membrane in contact with the composition.

Preferably, the perforations on the outer surface of the membrane do not touch each other.

Also preferably, the actuator is a piezoelectric actuator, for example designed in order to make the membrane vibrate in a frequency band that may range for example from 20 kHz to 7 MHz. The energy needed for the operation of the piezoelectric actuator may be obtained by virtue of an electrical generator, for example an electrical cell, a battery or a photovoltaic cell which may optionally be coupled to an electronic circuit.

In the spraying device defined above, the means for conveying the liquid cosmetic composition to the surface of the membrane may comprise a capillary feed mechanism, or alternatively, a bubble generator feed mechanism or else a pump of peristaltic, diaphragm, piston or gear type. Such mechanisms are described, for example, in International Application WO 95/15822.

According to one particular embodiment of the invention, all the perforations have a reverse conicity, or conversely the membrane comprises, in addition, perforations of normal conicity.

The expression “perforation of normal conicity” is understood, within the meaning of the present invention, to mean perforations for which the cross-sectional surface area is smaller on the outer surface of the membrane, facing the outside environment, than on the inner surface, facing the inside of the container.

When perforations of normal conicity are present, these are preferably positioned around and outside of perforations of reverse conicity.

The means for conveying the liquid cosmetic composition to the surface of the membrane may be designed in order to convey said composition to the inner surface of said membrane, or conversely be designed in order to convey said composition to the outer surface of said membrane. Such variants of the spraying device are described, for example, in International Application WO 95/15822.

By way of example, the membrane may be formed from an 8 mm diameter circular disc of electroformed nickel having a thickness of 70 μm and possessing a plurality of perforations. The perforations may have a cross-sectional surface area in the form of a circular disc, the diameter of which varies from 4 to 150 μm over the outer surface of the membrane, facing the outside environment, and on the inner surface, facing the inside of the container, a cross-sectional surface area in the shape of a circular disc, the diameter of which varies from 2 to 50 μm, and for example from 10 to 20 μm.

During the use of the device, the cosmetic composition emerges in the form of droplets, the average diameter of which is preferably between 20 and 100 μm, and more preferably still between 30 and 60 μm.

Technologies corresponding to this device have, in particular, been described in Applications WO 93/10910, U.S. Pat. No. 5,487,378, FR-A-2665572, U.S. Pat. No. 4,533,082; U.S. Pat. No. 5,518,179, U.S. Pat. No. 6,113,001, WO 06/066671.

For the diffusion of a fragranced composition, it may prove desirable to have an assembly that allows an easy replacement of a cartridge containing a product to be diffused by another cartridge containing a different product, while having cartridges produced at a cost compatible with a large-scale distribution.

According to one particular mode of the invention, it is possible to use a spraying assembly as disclosed by WO 06/125677. This is a spraying device having a ring made at least partially from a piezoelectric material and a perforated membrane vibrated by the ring, in which device the perforated membrane is held in the ring by clamping; the piezoelectric device having a container in order to supply the perforated membrane with product to be sprayed.

According to another particular mode of the invention, it is possible to use a spraying assembly such as that disclosed by U.S. Pat. No. 4,702,418. This assembly comprises an apparatus provided with an exciter member and a cartridge received in the apparatus, comprising a pressure chamber delimited on one side by a deformable wall that comes into contact with the exciter member and on the other side by a perforated grid through which droplets of product are ejected, in the axis of the region of the deformable wall that comes into contact with the exciter member. The exciter member may be fastened to a housing that receives the cartridge.

### Fragrance Concentrate

In the fragrance concentrate used in accordance with the invention, it is possible to use, in the composition of the invention, fragrances of natural or synthetic origin and mixtures thereof. As fragrances of natural origin, mention may be made, for example, of extracts of flowers (lily, lavender, rose, jasmine, ylang-ylang), of stems and of leaves (patchouli, geranium, petitgrain), of fruits (coriander, aniseed, cumin, juniper), of fruit peel (bergamot, lemon, orange), of roots (angelica, celery, cardamom, iris, sweet flag), of wood (pinewood, sandalwood, lignum vitae, cedarwood, rosewood), of herbs and of grasses (tarragon, lemongrass, sage, thyme), of needles and of branches (spruce, fir, pine, dwarf pine), of resins and of balsams (galbanum, elemi gum, benzoin resin, myrrh, olibanum, opopanax).

As a fragrancing substance of synthetic origin, mention may be made, for example, of compounds of the ester, ether, aldehyde, ketone, aromatic alcohol and hydrocarbon type.

As esters, mention may in particular be made of benzyl acetate, benzyl benzoate, phenoxyethyl isobutyrate, p-tert-butylcyclohexyl acetate, citronellyl acetate, citronellyl formiate, geranyl acetate, linalyl acetate, dimethylbenzylcarbinyl acetate, phenylethyl acetate, linalyl benzoate, benzyl formiate, ethylmethylphenyl glycinate, alkylcyclohexyl propionate, styralyl propionate and benzyl salicylate.

As ethers, mention may be made of benzyl ethyl ether.

As aldehydes, mention may be made, for example, of linear alkanes comprising 8 to 18 carbon atoms, citral, citronellal, citronellyloxyacetaldehyde, cyclamen aldehyde, hydroxycitronellal, lilial and bourgeonal.

As ketones, mention may be made, for example, of ionones such as alpha-isomethyl ionone, and methyl cedryl ketone.

Among the aromatic and in particular terpenic alcohols, mention may be made of anethole, citronellol, eugenol, isoeugenol, geraniol, linalool, phenylethyl alcohol and terpineol.

As hydrocarbons, mention may especially be made of terpenes such as, for example, menthol, nerol and limonene.

Furthermore, it is also possible to use essential oils, aroma components, such as for example the oils of sage, of chamomile, of clove, of balm, of mint, of cinnamon leaves, of lime leaves, of juniper, of vetiver, of olibanum, of galbanum, of labdanum and of lavender.

Preferably use is made, as a fragrancing substance, alone or as a mixture, of the oil of bergamot, dihydromyrcenol, lilial, lyral, citronellol, phenylethyl alcohol, alpha-hexylcinnamaldehyde, geraniol, benzylacetone, cyclamen aldehyde, linalool, ambroxan, indole, hedione, sandelice, the oils of lemon, of mandarin and of orange, allylamine glycolate, cyclovertal, lavender oil, sage oil, beta-damascone, geranium oil, cyclohexyl salicylate, phenylacetic acid, geranyl acetate, benzyl acetate, rose oxide.

According to one preferred embodiment of the invention, a mixture of various fragrancing substances is used which generate, through their common synergy, a pleasant note for the user. Among the known olfactory notes, mention may be made, for example, of hesperide fragrances, aromatics, floral fragrances, musks, fruity fragrances, spices, oriental fragrances, oceanic fragrances, aquatic notes, chypre fragrances, woody fragrances, fougeres and mixtures thereof.

The viscosity of the fragrancing composition is less than or equal to 8 mPa·s and will vary depending on its application (skin or surrounding air). It will preferably vary from 1 to 8 mPa·s. This is measured at 20° C. using a HAAKE Rheostress 600 machine with a spindle having a diameter of 60 mm, an angle of 2° and a sand-blasted coating at a shear rate of 200 s⁻¹.

### Non-Volatile Solvents for the Fragrance

The non-volatile solvents according to the present invention are preferably chosen from esters, ethers, polyols and fatty alcohols.

Their viscosity will preferably vary from 1 to 120 mPa·s. This is measured at 20° C. using a HAAKE Rheostress 600 machine with a spindle having a diameter of 60 mm, an angle of 20, and a sand-blasted coating at a shear rate of 200 s⁻¹.

Their density is less than 1. This can be measured at 20° C. using a METTLER TOLEDO DE 45 densimeter.

By way of example of non-volatile solvents, mention may be made of 2-octyldodecyl neopentanoate, isodecyl neopentanoate and dicaprylyl ether.

Use will more particularly be made of 3-methoxy-3-methyl-1-butanol and isopropyl myristate.

### Volatile Solvent

The volatile solvents according to the invention are preferably chosen from volatile alcohols.

The expression “volatile alcohol” is understood to mean any compound comprising at least one alcohol functional group having a vapour pressure at 20° C. greater than 17.5 mmHg.

The volatile alcohols according to the present invention are preferably chosen from C₁-C₅ lower monoalcohols such as, for example, methanol, ethanol, propanol, isopropanol, n-butanol, isobutanol, tert-butanol and more particularly ethanol. Their viscosity will preferably vary from 0.5 to 3 mPa·s. This is measured at 20° C. using a HAAKE Rheostress 600 machine with a spindle having a diameter of 60 mm, an angle of 2° and a sand-blasted coating at a shear rate of 200 s⁻¹.

The concentration of volatile solvent is from 0.5% to 50% by weight relative to the total weight of the composition. Below 0.5% by weight the diffusion of the fragrance cannot be achieved. More preferably, it will vary from 0.5 to 25% and more preferably still from 0.5 to 16% by weight.

### Additives

The composition of the invention may comprise, in addition, any additive customarily used in the field of fragrances in particular chosen from antioxidants, UV sunscreens, stabilizers, dyestuffs, preservatives (for example phenoxyethanol and parabens), bactericides or mixtures thereof.

Among the antioxidants, mention may be made, for example, of BHA (tert-butyl-4-hydroxyanisole), BHT (2,6-di-tert-butyl-p-cresol), tocopherols such as vitamin E and derivatives thereof such as tocopheryl acetate.

The composition according to the invention may especially comprise at least one dyestuff, in particular liposoluble dyes and water-soluble dyes.

The soluble dyes are, for example: caramel, Yellow 5, Acid Blue 9/Blue 1, Green 5, Green 3/Fast Green FCF 3, Orange 4, Red 4/Food Red 1, Yellow 6, Acid Red 33/Food Red 12, Red 40, cochineal carmine (CI 15850, CI 75470), Ext. Violet 2, Red 6-7, Ferric Ferrocyanide, Ultramarines, Acid Yellow 3/Yellow 10, Acid Blue 3, Yellow 10.

The liposoluble dyes are, for example, Sudan red, D&C Red 17, D&C Green 6, β-carotene, soybean oil, Sudan brown, D&C Yellow 11, D&C Violet 2, D&C Orange 5, quinoline yellow, annatto.

The composition according to the invention may thus constitute a fragrancing composition in the form of eau fraîche (splash), eau de toilette, eau de parfum, extracts having a high percentage of fragrance concentrate, aftershave lotion, eau de soin (skincare water) and more particularly home fragrance.

Another subject of the invention is a cosmetic method of fragrancing keratin materials of human beings and especially of the skin, lips and integuments, comprising the application to the keratin materials of the composition as defined above.

The composition according to the invention may be manufactured by known methods, generally used in the field of fragranced compositions.

The fragrancing compositions according to the invention are in all galenic forms suitable for piezoelectric-type diffusers, especially in the form of an alcoholic or aqueous-alcoholic solution. These compositions are prepared according to the usual methods.

The invention will now be described with reference to the following examples given by way of illustration and non-limitingly. In these examples, unless indicated otherwise, the amounts are expressed as percentages by weight. The following fragranced formulations were produced; the amounts are indicated in percentages by weight:

### EXAMPLE 1

### Influence of the Viscosity of the Composition on the Diffusion

The following formulations+piezoelectric atomizer assemblies 1 to 8 were prepared.

| Ingredients | EX 1 | EX 2 | EX 3 | EX 4 | EX 5 | EX 6 | EX 7 | EX 8 |
|---|---|---|---|---|---|---|---|---|
| Sesame souffle | 50 | 50 | 20 | 10 | — | — | — | — |
| fragrance | | | | | | | | |
| Liquorice | — | — | — | — | 15 | 15 | 10 | 7 |
| violet | | | | | | | | |
| fragrance | | | | | | | | |
| Ethanol | 12 | 12 | 15 | 16 | 17 | 17 | 17 | 17 |
| 3-methoxy-3- | 38 | — | — | — | 68 | — | — | — |
| methyl-1- | | | | | | | | |
| butanol | | | | | | | | |
| (7 mPa · s) | | | | | | | | |
| Isopropyl | — | 38 | 65 | 74 | | 68 | 73 | 76 |
| myristate | | | | | | | | |
| (5.3 mPa · s) | | | | | | | | |
| Viscosity of the | 8.4 | 6.8 | 4.6 | 4.3 | 5.8 | 4.7 | 4.3 | 4.2 |
| composition | | | | | | | | |
| (mPa · s) | | | | | | | | |
| Diffusion | − | + | +++ | ++++ | + | +++ | ++++ | ++++ |

Each of these fragrancing formulations was incorporated into a piezoelectric spraying device such as described in Application WO 06/125677 comprising a cartridge in order to supply the perforated membrane with product to be sprayed. Said cartridge was filled using a Rainin pipette with 1 ml of the composition to be tested. The diffusion was carried out for 30 continuous minutes, with monitoring every 10 minutes. The quality of the diffusion obtained was defined in the following manner:

| | |
|---|---|
| − | No diffusion, or very rapid |
| | clogging of the apparatus |
| | (in less than 10 seconds) |
| + | Medium diffusion |
| ++ | Correct diffusion |
| +++ | Good diffusion |
| ++++ | Very good diffusion: a |
| | large volume, great height, |
| | no clogging of the |
| | apparatus. |

### EXAMPLE NO. 2

### Effect of the Density of the Non-Volatile Solvent

The following formulation+piezoelectric atomizer assemblies 15 to 20 were produced:

Measurement of the density at 20° C. using the METTLER TOLEDO DE 45 machine. The measurement of the density of the solutions to be diffused by the system revealed families of solutions grouped according to the solvent put in solution and regardless of their viscosities. Each of these fragrancing solutions was incorporated into a piezoelectric spraying device identical to that from Example 1. The cartridge was filled using a Rainin pipette with 1 ml of the solution to be tested.

The frequency of the apparatus was set at:

diffusion time=300 milliseconds;
down time=1 second

| Ingredients | EX 15 | EX 16 | EX 17 | EX 18 | EX 19 | EX 20 |
|---|---|---|---|---|---|---|
| Tiare Tahiti | 28 | 28 | 28 | 28 | 28 | — |
| fragrance | | | | | | |
| Vetiver petal | — | — | — | — | — | 50 |
| fragrance | | | | | | |
| Non-denatured | 3 | 23 | 30 | 40 | 3 | 15.5 |
| ethanol | | | | | | |
| Triethyl citrate | — | 49 | 42 | | — | — |
| (36 mPa · s) | | | | | | |
| Dipropylene | — | — | — | 32 | — | |
| glycol | | | | | | |
| (119 mPa · s) | | | | | | |
| Octyldodecyl | — | — | — | — | — | |
| neopentanoate | | | | | | |
| (17 mPa · s) | | | | | | |
| Isopropyl | 69 | — | — | — | 69 | |
| myristate | | | | | | |
| (5.3 mPa · s) | | | | | | |
| 3-methoxy-3- | — | — | — | — | — | 34.5 |
| methyl-1- | | | | | | |
| butanol | | | | | | |
| (7 mPa · s) | | | | | | |
| Viscosity | 5.7 | 5.7 | 4.5 | 5 | 5.7 | 5.4 |
| (mPa · s) | | | | | | |
| Density of | 0.85 | 1.13 | 1.13 | 1.02 | 0.85 | 0.92 |
| the non- | | | | | | |
| volatile solvent | | | | | | |
| Diffusion | +++ | − | − | − | +++ | +++ |

These results show that when the density of the non-volatile solvent is greater than 1, the diffusion is not carried out.

### EXAMPLE NO. 3

### Influence of the Volatile Solvent

These tests were carried out in order to show the influence of the addition of the volatile solvent on the diffusion of the solution within the apparatus.

The following formulation+piezoelectric atomizer assemblies 9 to 14 were produced.

| | | EX | EX | EX | EX | EX |
|---|---|---|---|---|---|---|
| Ingredients | EX 9 | 10 | 11 | 12 | 13 | 14 |
| Jingle Bell | 10 | 10 | 10 | 10 | 10 | 10 |
| fragrance | | | | | | |
| Non-denatured | — | 0.4 | 0.5 | — | 0.4 | 0.5 |
| ethanol | | | | | | |
| Isopropyl | qs 100 | qs 100 | qs 100 | — | — | — |
| myristate | | | | | | |
| (5.3 mPa · s) | | | | | | |
| 3-methoxy-3- | | | | qs 100 | qs 100 | qs 100 |
| methyl-1- | | | | | | |
| butanol | | | | | | |
| (7 mPa · s) | | | | | | |
| Viscosity | 5.53 | 5.49 | 5.5 | 7 | 5.39 | 5.52 |
| (mPa · s) | | | | | | |
| Diffusion | − | − | + | − | − | + |

Each of these fragrancing solutions was incorporated into a piezoelectric spraying device identical to that from Example 1. The cartridge was filled using a Rainin pipette with 1 ml of the solution to be tested.

The frequency of the apparatus was set at:

diffusion time=300 milliseconds;
down time=1 second.

These results show that when the content of volatile solvent is below 0.5% by weight of volatile solvent, the diffusion is not carried out.

### EXAMPLE NO. 4

### Longevity of the Formulations

The following formulation+piezoelectric atomizer assemblies 21 to 25 were produced.

| | EX | EX | EX | EX | EX |
|---|---|---|---|---|---|
| Ingredients | 21 | 22 | 23 | 24 | 25 |
| Tiare Tahiti fragrance | 10 | 10 | 10 | 10 | 10 |
| Non-denatured ethanol | 10 | 16 | 50 | 75 | 90 |
| Isopropyl myristate | qs 100 | qs 100 | qs 100 | qs 100 | qs 100 |

Each of these fragrancing solutions was incorporated into a piezoelectric spraying device identical to that from Example 1. The cartridge was filled using a Rainin pipette with 1 ml of the composition to be tested.

The percentage evaporation of the solutions introduced into the cartridges placed in an oven at 37° C. was measured.

The weighings were taken at T =

| | | | | | | | | |
|---|---|---|---|---|---|---|---|---|
| Time | 1 | 3.66 | 7 | 24 | 48 | 72 | 144 | 168 |
| (hours) | | | | | | | | |

The following results were obtained:

### Results:

| | % evap | % evap | % evap | % evap | % evap |
|---|---|---|---|---|---|
| Time | 10% | 16% | 50% | 75% | 90% |
| (hours) | ethanol | ethanol | ethanol | ethanol | ethanol |
| 1 | 1.97 | 2.2 | 3.78 | 5.6 | 4.11 |
| 3.66 | 5.66 | 6.52 | 9.48 | 11.82 | 13.79 |
| 7 | 8.43 | 10.99 | 15.97 | 19.19 | 25.73 |
| 24 | 10.45 | 16.24 | 44.45 | 53.55 | 80.16 |
| 48 | 10.71 | 16.74 | 50.45 | 74.91 | 90.32 |
| 72 | 10.88 | 16.98 | 50.89 | 75.57 | 90.66 |
| 144 | 11.2 | 17.49 | 51.59 | 76.29 | 91.25 |
| 168 | 11.25 | 17.61 | 51.72 | 76.41 | 91.39 |

### CONCLUSION

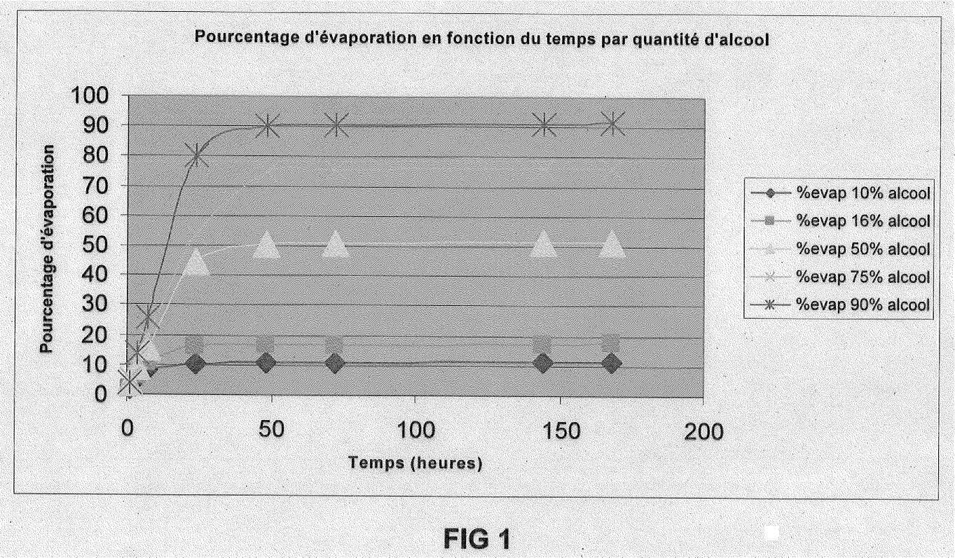

The graph from FIG. 1 shows that the curves reach a plateau from 48 hours of the oven test (37° C.). This oven test was carried out in order to accelerate the general evaporation process at ambient temperature. The maximum evaporation for all the solutions was reached. If a maximum evaporation of 50% is set in order to avoid deceiving the consumer and to provide a quality product, it is observed that it is necessary not to go beyond 50%, and preferably 16%, alcohol.

1. Assembly comprising:
(A) a composition contained inside a reservoir, said composition being liquid and comprising, in a physiologically acceptable medium, at least:
(i) from 1 to 90% by weight of a fragrance concentrate;
(ii) from 1 to 98.5% by weight of at least one non-volatile solvent for said concentrate having a density of less than 1;
of said fragrance;
(iii) at least from 0.5% to 50% by weight of at least one volatile solvent for said concentrate; said composition having a viscosity less than or equal to 8 mPa·s; the amounts being defined relative to the total weight of the composition;
(B) a spraying device comprising a container containing said liquid cosmetic composition, equipped with a piezoelectric spraying mechanism that makes it possible to spray the cosmetic composition in the form of droplets.

2. Assembly according to claim 1, characterized in that the container equipped with a spraying mechanism comprises:
a perforated membrane, the perforations of the membrane connecting the inside of the container with the outside environment;
a piezoelectric transducer;
a means for bringing the liquid cosmetic composition contained in the container into contact with an internal surface of the membrane,
the cosmetic composition, under the effect of vibrations, flowing through the perforations to an external surface of the membrane, from where it emerges in the form of droplets.

3. Assembly according to claim 2, characterized in that the piezoelectric transducer makes said membrane vibrate.

4. Assembly according to claim 1, comprising a piezoelectric spraying device having a ring made at least partially from a piezoelectric material and a perforated membrane vibrated by the ring, in which device the perforated membrane is held in the ring by clamping; the piezoelectric device having a container in order to supply the perforated membrane with product to be sprayed.

5. Assembly according to claim 1, comprising a piezoelectric spraying device provided with an exciter member and a cartridge received in the apparatus, comprising a pressure chamber delimited on one side by a deformable wall that comes into contact with the exciter member and on the other side by a perforated grid through which droplets of product are ejected, in the axis of the region of the deformable wall that comes into contact with the exciter member; the exciter member possibly being fastened to a housing that receives the cartridge.

6. Assembly according to claim 1, where the volatile solvent is chosen from C₁-C₅ lower monoalcohols, in particular ethanol.

7. Assembly according to claim 1, where the viscosity of the volatile solvent varies from 0.5 to 3 mPa·s.

8. Assembly according to claim 1, where the concentration of volatile solvent varies from 0.5 to 25% and more preferably still from 0.5 to 16% by weight.

9. Assembly according to claim 1, where the viscosity of the liquid fragrancing composition is from 0.5 to 8 mPa·s.

10. Assembly according to claim 8, where the concentration of volatile solvent varies from 0.5 to 25% and more preferably still from 0.5 to 15% by weight.

11. Assembly according to claim 1, where the non-volatile solvent for the fragrance is chosen from esters, ethers, polyols, fatty alcohols, in particular chosen from 3-methoxy-3-methyl-1-butanol and isopropyl myristate.

12. Assembly according to claim 1, where the viscosity of the non-volatile solvent for the fragrance is from 5 to 120 mPa·s.

13. Assembly according to claim 1, where the liquid composition contained in the spraying device is in the form of eau fraîche (splash), eau de toilette, eau de parfum, extrait de parfum (perfume extract), aftershave lotion, eau de soin (skincare water) or home fragrance.

14. Method of fragrancing human keratin materials and especially skin, lips, hair, scalp, nails, comprising at least one step of spraying a fragrancing composition by means of a device as defined claim 1.

15. Method of fragrancing the surrounding air comprising at least one step of spraying a fragrancing composition by means of a device as defined in claim 1.

16. Assembly according to claim 2, comprising a piezoelectric spraying device having a ring made at least partially from a piezoelectric material and a perforated membrane vibrated by the ring, in which device the perforated membrane is held in the ring by clamping; the piezoelectric device having a container in order to supply the perforated membrane with product to be sprayed.

17. Assembly according to claim 3, comprising a piezoelectric spraying device having a ring made at least partially from a piezoelectric material and a perforated membrane vibrated by the ring, in which device the perforated membrane is held in the ring by clamping; the piezoelectric device having a container in order to supply the perforated membrane with product to be sprayed.

18. Assembly according to claim 2, comprising a piezoelectric spraying device provided with an exciter member and a cartridge received in the apparatus, comprising a pressure chamber delimited on one side by a deformable wall that comes into contact with the exciter member and on the other side by a perforated grid through which droplets of product are ejected, in the axis of the region of the deformable wall that comes into contact with the exciter member; the exciter member possibly being fastened to a housing that receives the cartridge.

19. Assembly according to claim 2, comprising a piezoelectric spraying device provided with an exciter member and a cartridge received in the apparatus, comprising a pressure chamber delimited on one side by a deformable wall that comes into contact with the exciter member and on the other side by a perforated grid through which droplets of product are ejected, in the axis of the region of the deformable wall that comes into contact with the exciter member; the exciter member possibly being fastened to a housing that receives the cartridge.

20. Assembly according to claim 2, where the volatile solvent is chosen from C₁-C₅ lower monoalcohols, in particular ethanol.
